(19) United States
(12) Patent Application Publication
(10) Pub. No.: US 2026/0279120 A1
(43) Pub. Date: Sep. 17, 2026

(54) CAMERA-ENABLED LOCK SYSTEM

(71) Applicant: Master Lock Company LLC, Oak Creek, WI (US)

(72) Inventors: Garrett Lovejoy, Raleigh, NC (US); Mason Hall, Oak Creek, WI (US); John McGuire, Oak Creek, WI (US)

(73) Assignee: Master Lock Company LLC, Oak Creek, WI (US)

(21) Appl. No.: 19/562,440

(22) Filed: Mar. 10, 2026

Related U.S. Application Data
(60) Provisional application No. 63/770,338, filed on Mar. 11, 2025.

(51) Int. Cl. G07C 9/00

(52) U.S. Cl. CPC G07C 9/00563; G07C 9/00571

(57) ABSTRACT

A lock system includes a receptacle, a sensor, and one or more processing circuits. The receptacle includes a storage compartment defining a storage volume and a lock transitionable between a locked configuration and an unlocked configuration. The sensor is configured to acquire sensor data regarding contents added to or removed from the storage volume by a user. The one or more processing circuits are configured to acquire the sensor data from an access event associated with the receptacle, identify, based on the sensor data, at least one item of the contents added to or removed from the storage volume during the access event, determine, based on the sensor data and the at least one item, whether the access event is associated with an anomaly condition, and generate an alert signal in response to determining that the access event is associated with the anomaly condition.

### CROSS-REFERENCE TO RELATED PATENT APPLICATION

This application claims the benefit of and priority to U.S. Provisional Patent Application No. 63/770338, filed Mar. 11, 2025, which is incorporated herein by reference in its entirety.

### BACKGROUND

Lock boxes such as safes are commonly used to lock and secure contents therein.

Traditional lock boxes may use a mechanical locking mechanism as the only measure to selectively provide access to the contents stored therein, and may lack advanced features to provide enhanced security.

### SUMMARY

One embodiment relates to a lock system. The lock system includes a receptacle, a sensor, and one or more processing circuits. The receptacle includes a storage compartment defining a storage volume and a lock transitionable between a locked configuration and an unlocked configuration. In the locked configuration, access to the storage volume is inhibited. In the unlocked configuration, access to the storage volume is permitted. The sensor is configured to acquire sensor data regarding contents added to or removed from the storage volume by a user. The one or more processing circuits are configured to acquire the sensor data from an access event associated with the receptacle, identify, based on the sensor data, at least one item of the contents added to or removed from the storage volume during the access event, determine, based on the sensor data and the at least one item, whether the access event is associated with an anomaly condition, and generate an alert signal in response to determining that the access event is associated with the anomaly condition.

Another embodiment relates to a lock system. The lock system includes one or more processing circuits configured to acquire sensor data from an access event associated with a receptacle, the receptacle including a storage compartment defining a storage volume configured to store contents and a lock configured to permit selective access to the storage volume, identify, based on the sensor data, at least one item of the contents added to or removed from the storage volume during the access event, determine, based on the sensor data and the at least one item, whether the access event is associated with an anomaly condition, and generate an alert signal in response to determining that the access event is associated with the anomaly condition. The one or more processing circuits are configured to determine that the access event is associated with the anomaly condition in response to a first number of items identified as added to or removed from the storage volume during the access event being different from an expected number of items to be added to or removed from the storage volume.

Still another embodiment relates to a lock system. The lock system includes a receptacle, a sensor, and one or more processing circuits. The receptacle includes a storage compartment defining a storage volume and a lock transitionable between a locked configuration and an unlocked configuration, wherein, in the locked configuration, access to the storage volume is inhibited, and, in the unlocked configuration, access to the storage volume is permitted. The sensor is configured to acquire sensor data regarding contents stored in, added to, or removed from the storage volume by a user. The one or more processing circuits are configured to acquire the sensor data, identify, based on the sensor data, one or more items of the contents stored in the storage volume, maintain a digital inventory representing the contents stored in the storage volume, the digital inventory including a digital copy of the one or more items of the contents, and update the digital inventory based on a respective item of the contents being added to or removed from the storage volume.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a receptacle in a closed position, according to an exemplary embodiment.

FIG. 2 is a perspective view of the receptacle of FIG. 1 in an open position, according to an exemplary embodiment.

FIG. 3 is a top view of a floor plan including the receptacle of FIG. 1 and an external device in an indoor environment, according to an exemplary embodiment.

FIG. 4 is a front view of the receptacle of FIG. 1 and an external device in an outdoor environment, according to an exemplary embodiment.

FIG. 5 is a block diagram of a lock system for wireless communication (i) between one or more servers and one or more external devices, (ii) between the one or more servers and the receptacle of FIG. 1, and (iii) between the one or more external devices and the receptacle of FIG. 1, according to an exemplary embodiment.

FIG. 6 is a block diagram of the receptacle of FIG. 1, according to an exemplary embodiment.

FIG. 7 is a block diagram of the one or more external devices of FIG. 5, according to an exemplary embodiment.

FIG. 8 is a block diagram of the one or more servers of FIG. 5, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

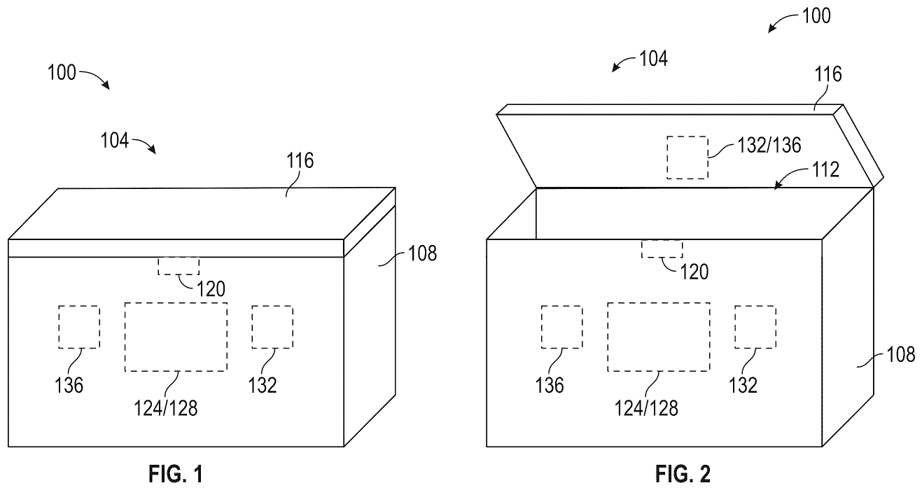

As shown in FIGS. 1-5, a security system (e.g., lock box security system, receptacle securing system, etc.), shown as lock system 100, includes a lock box (e.g., safe, smart safe, a key safe, a gun safe, smart filing cabinet, storage container, smart storage, etc.), shown as receptacle 104; one or more devices external (e.g., remote) from the receptacle 104, shown as external devices 200, including at least one user device (e.g., mobile phone, tablet, computer, smart watch, electronic key, key fob, etc.), shown as user device 204, at least one vision sensor, shown as camera 208, a smart locking mechanism, shown as lock 212, a doorbell (e.g., video doorbell), shown as smart doorbell 216, a door (e.g., sliding door, pivoting door, etc.), shown as smart door 220, a security system, shown as home security system 224, and/or a water monitoring system 228; and one or more remote severs (e.g., credential management server, profile management server, receptacle contents management server, etc.), shown as server 300, in communication with the receptacle 104 and the external devices 200. Generally, the lock system 100 is configured to facilitate (i) providing selective access to the receptacle 104 based on authentication data and (ii) managing content such as personal belongings (e.g., jewelry, electronics, money, etc.), documents (e.g., tax documents, certificates, titles, etc.), among other content configured to be stored in the receptacle 104.

One or more servers, as used herein, may be implemented using any type of computing device or devices and/or hardware and/or software architectures, including, but not limited to, a single computing device, multiple computing devices operating separately or in concert with one another, a distributed computing system, a cloud computing system, or any other type of system. Further, where the present disclosure discusses utilizing a processor and a memory, it should be understood that, in various implementations, a single processor and/or a single memory may be used or multiple processors and/or multiple memories or other computer-readable storage media may be used, and all such implementations are contemplated within the scope of the present disclosure.

As shown in FIGS. 1 and 2, the receptacle 104 includes a body, shown as storage compartment 108, defining an interior chamber (e.g., internal volume, etc.), shown as storage volume 112, and a lid, shown as door 116, coupled with the storage compartment 108 and configured to move (e.g., translate, pivot, slide, etc.) relative to the storage compartment 108 to provide selective access to the storage volume 112. While the door 116 is shown positioned along the top of the storage compartment 108 such that the storage volume 112 is accessible from above, it should be understood that the door 116 may be otherwise positioned along the storage compartment 108 (e.g., along a front, left, right, back, or bottom side) to provide selective access to the storage volume 112. In some embodiments, the receptacle 104 does not include the door 116. By way of example, the receptacle 104 may be configured as a drawer movably coupled with a support structure (e.g., a cabinet, a wall of a building, etc.) such that access to the storage volume 112 is provided by transitioning the storage compartment 108 from a stowed position to an extended position.

In some embodiments, the receptacle 104 is secured to a permanent structure (e.g., bolted, welded, etc., to the ground or a wall) such that the receptacle 104 cannot be easily picked up and removed. The receptacle 104 may be manufactured in a range of sizes and configurations depending on the intended use. Smaller receptacles 104 may be used for temporary storage of contents (e.g., leaving a key for a pet sitter), while larger receptacles 104 may be used for package delivery and acceptance, for example.

As shown in FIGS. 1, 2, and 6, the receptacle 104 includes at least one lock (e.g., locking mechanism, latch, deadbolt, electromagnet, etc.), shown as lock 120, configured to selectively transition between a locked state and an unlocked state to selectively lock and unlock the receptacle 104. In the locked state, the lock 120 inhibits access to the receptacle 104 (e.g., the storage volume 112 of the storage compartment 108), and, in the unlocked state, the lock 120 permits access to the receptacle 104. By way of example, in the locked state, the lock 120 may inhibit moving the door 116 to the open position or inhibit transitioning the storage compartment 108 from the stowed position to the extended position to inhibit access to the receptacle 104. By way of another example, in the unlocked state, the lock 120 may permit moving the door 116 to the open position or permit transitioning the storage compartment 108 from the stowed position to the extended position to permit access to the receptacle 104. In some embodiments, the lock 120 includes a deadbolt configured to move between a locked position and an unlocked position to transition the lock 120 between the locked state and the unlocked state. In other embodiments, the lock 120 includes an electromagnetic mechanism (e.g., an electromagnet) configured to selectively magnetically lock the receptacle 104. In still other embodiments, the lock 120 includes another suitable device configured to selectively lock the receptacle 104. In some embodiments, the receptacle 104 includes two or more locks 120.

As shown in FIGS. 1, 2, and 6, the receptacle 104 includes one or more operator interfaces, shown as input device 124 and output device 128. In some embodiments, the input device 124 and output device 128 are mounted (e.g., located, installed, integrated, etc.) along an exterior surface of receptacle 104 (e.g., along the storage compartment 108, along the door 116, etc.). The input device 124 may include one or more keypads, human machine interfaces (HMIs) including one or more input controls (e.g., touchscreens, buttons, knobs, thumb turns, dials, switches, levers, etc.), or the like. The input device 124 may facilitate user control of one or more components of the receptacle 104. In some embodiments, as discussed in greater detail below, the lock system 100 requires at least a password authentication from the user via the input device 124 to transition the receptacle 104 between the locked state and the unlocked state. The password may depend on the type of the input device 124. By way of example, if the input device 124 includes a keypad and/or HMI, the password may be a sequence of inputs (e.g., a sequence of digits, letters, buttons; a one-time code; a unique identifier; etc.). In such an example, in response to receiving a user input (e.g., the password) to the input device 124, the lock system 100 may compare (e.g., locally via the receptacle controller 160 and/or the user device controller 250, remotely via the server 300, etc.) the user input to a stored authenticator key. Additionally or alternatively, the input device 124 may include a key hole configured to receive a physical key to manually transition the receptacle 104 between the locked state and the unlocked state. In some embodiments, the lock system 100 does not require a password, a physical key, or other input to the input device 124 to transition the receptacle 104 from the unlocked state to the locked state.

According to an exemplary embodiment, the output device 128 includes one or more displays (e.g., LCD displays, LED displays, etc.), lights (e.g., warning lights, LEDs, spotlights, etc.), speakers. The output device 128 is configured to provide information to the user indicative of the operation of the receptacle 104. In some embodiments, the information provided by the output device 128 includes an indication of whether the receptacle 104 (e.g., the lock 120 thereof) is in a locked state or an unlocked state. By way of example, the display may provide a message, symbol, etc., the lights may emit a light (e.g., red light, green light, pattern of flashing lights, etc.), and/or the speaker may play a sound (e.g., audio message, tone, etc.) indicative of whether the receptacle 104 is in the locked state or the unlocked state.

As shown in FIGS. 1, 2, and 6, the receptacle 104 includes one or more sensors (e.g., proximity sensors, motion sensors, position sensors, vision sensors, radar sensors, cameras, force sensors, microphones, biometric sensors, etc.), shown as sensors 132, variously positioned about the receptacle 104 and configured to monitor operation of the receptacle 104 and the area surrounding the receptacle 104. By way of example, the sensors 132 may include a position sensor configured to monitor a position of the door 116 to determine whether the door 116 is in the open position or the closed position. By way of another example, the sensors 132 may include a position sensor configured to monitor a position of the storage compartment 108 to determine whether the storage compartment 108 is in the stowed position or the extended position. By way of still another example, the sensors 132 may include a biometric sensor such as a fingerprint sensor, a facial recognition sensor, an iris/retinal sensor, a gait recognition sensor, a microphone (e.g., voice detection sensor), etc., configured to facilitate identifying the user attempting to access the receptacle 104. In such an example, the data acquired by the biometric sensor may be used as an input (e.g., password) to lock or unlock the receptacle 104. By way of yet another example, the sensors 132 may include a position sensor configured to monitor a position or state of the lock 120 to facilitate determining whether the receptacle 104 is in the locked state or the unlocked state. By way of still another example, the sensors 132 may include a force or movement sensor (e.g., load cell, strain gauge, accelerometer, gyroscope, etc.) configured to monitor a force, a stress, an acceleration, and/or a movement applied to the receptacle 104, which may be indicative of an unauthorized attempt to access the receptacle 104. By way of still another example, the sensors 132 may include a motion sensor configured to facilitate monitoring an area surrounding the receptacle 104 to facilitate detecting users (e.g., authorized and unauthorized users), objects, etc., around the receptacle 104.

As shown in FIGS. 1, 2, and 6, the receptacle 104 includes one or more vision sensors (e.g., cameras, LIDAR sensors, radar sensors, etc.), shown as cameras 136, configured to acquire vision data of the area surrounding the receptacle 104. Based on the vision data acquired by the cameras 136, the lock system 100 may be configured to detect and/or identify one or more objects (e.g., people, animals, vehicles, shipping packages or other deliveries, etc.), one or more events (e.g., arrivals, departures, weather conditions, crimes, property damage, etc.), and/or other conditions. By way of example, the vision data acquired by the cameras 136 may be used to identify (e.g., using facial recognition, gait recognition, etc.) a user authorized to access the receptacle 104. One or more of the cameras 136 may be positioned along an exterior of the receptacle 104. As shown in FIG. 2, the receptacle 104 includes one or more cameras 136 positioned to monitor the contents entering and leaving the storage volume 112. In some embodiments, the cameras 136 are positioned along a bottom side of the door 116. In other embodiments, the cameras 136 are positioned along an interior wall of the storage compartment 108 within the storage volume 112. As discussed in greater detail below, the vision data acquired by the cameras 136 may be used to identify, scan, and log (e.g., store, track, etc.) the contents stored within the storage volume 112 (e.g., the contents entering or placed in the storage volume 112, the contents removed or taken out of the storage volume 112, etc.).

In some embodiments, the receptacle 104 includes a power source (e.g., battery) configured to provide power to the one or more components (e.g., the lock 120, the input device 124, the output device 128, the sensors 132, the cameras 136, etc.). In other embodiments, the receptacle 104 is electrically coupled to an external power source and configured to receive electrical energy therefrom to power the one or more components thereof.

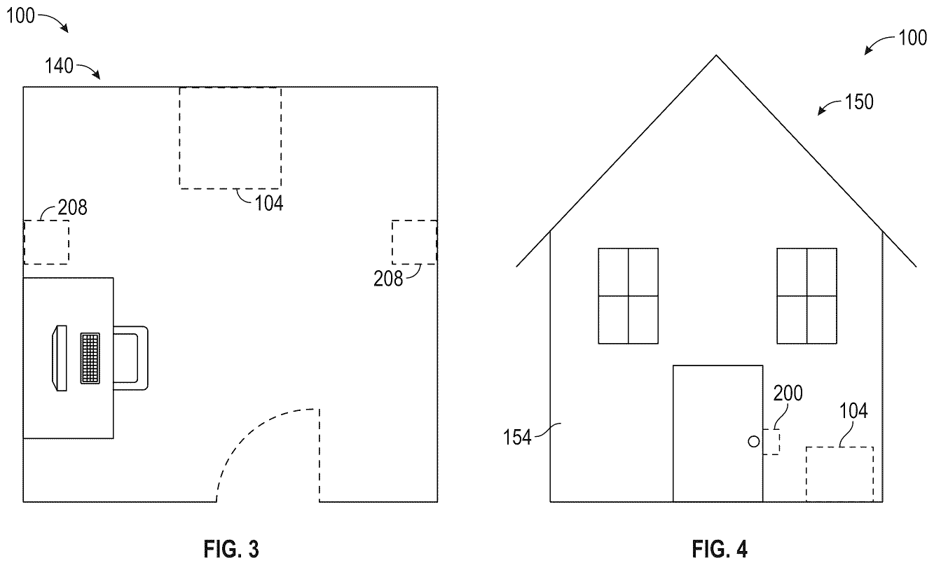

As shown in FIG. 3, an interior environment (e.g., room, office, bedroom, warehouse, safe, etc.), shown as floor plan 140, includes the receptacle 104 and the cameras 208 disposed therein. The cameras 208 may include the same functionality as the cameras 136 discussed above. According to an exemplary embodiment, the cameras 208 are positioned within the floor plan 140 remote from the receptacle 104 (e.g., external from the receptacle 104) to monitor the receptacle 104 and the area surrounding the receptacle 104 (e.g., to monitor the floor plan 140). By way of example, the cameras 208 may be positioned to acquire vision data including an entrance of the floor plan 140 to facilitate detecting people entering the floor plan 140. By way of another example, the cameras 208 may be positioned to acquire vision data including (i) the contents entering or placed in the storage volume 112, (ii) the contents removed or taken out of the storage volume 112, and/or (iii) the identity of the person placing the contents into and/or removing the contents from the storage volume 112. In such an example, the cameras 208 may be positioned directly vertically above the receptacle 104 (e.g., coupled to a ceiling of the floor plan 140), offset from the receptacle 104 along one or more walls of the floor plan 140, or otherwise suitably positioned. In some embodiments, a first camera 208 is positioned adjacent a first side of the receptacle 104 and a second camera 208 is positioned adjacent a second side of the receptacle 104. In such embodiments, the first camera 208 may acquire vision data occluded from the second camera 208 by a user or an object, for example, and the second camera 208 may acquire vision data occluded from the first camera 208 by the user or the object, for example. Similarly, the cameras 136 may acquire vision data occluded from the first camera 208 and/or the second camera 208. In other embodiments, the lock system 100 includes more or fewer than two cameras 208 variously positioned about the floor plan 140.

As shown in FIG. 4, an exterior environment (e.g., residential property, commercial property, etc.), shown as exterior environment 150, includes a structure (e.g., house, office, garage, warehouse, dwelling, etc.), shown as building 154, the receptacle 104 outside of the building 154, and one or more of the external devices 200 such as the cameras 208, the lock 212, the smart doorbell 216, the smart door 220, and/or the home security system 224 integrated with (e.g., coupled to, installed with, etc.) the building 154. According to an exemplary embodiment, the home security system 224 includes the cameras 208, the lock 212, the smart doorbell 216, and the smart door 220. The smart door 220 may be movably coupled with the building 154 to provide selective access to the interior of the building 154. The lock 212 may be coupled with the building 154 and may be configured to selectively transition between a locked configuration and an unlocked configuration to selectively transition the smart door 220 between a locked state in which access to the interior of the building 154 is permitted, and an unlocked state in which access to the interior of the building 154 is inhibited. The smart doorbell 216 may include a camera (e.g., one or more of the cameras 208) configured to monitor an area surrounding the building 154. In some embodiments, the camera 208, the lock 212, and/or the smart doorbell 216 are integrated with the smart door 220. In other embodiments, the camera 208, the lock 212, and/or the smart doorbell 216 are separate from the smart door 220.

In some embodiments, the home security system 224 operates cooperatively (e.g., is in communication) with the lock system 100 such that data (e.g., vision data, permission data, authentication data, etc.) is shared between the lock system 100 and the home security system 224. In such embodiments, the lock system 100 may send information generated by the lock system 100 to the other systems or receive information from the other systems. By way of example, a user may wish to share image data captured by the camera 136 and/or the cameras 208 on social media. In response to such a command, the lock system 100 may send the image data to a third party social media website. By way of another example, the user may utilize the home security system 224 that operates outside of the lock system 100. The lock system 100 may share image data from the camera 136 and/or the cameras 208 with the home security system 224, or vice versa to replace or supplement the functionality of the camera 136 and/or the cameras 208. By way of example, the lock system 100 may receive vision data acquired by the smart doorbell 216 to supplement or replace vision data acquired by the camera 136 and/or the cameras 208 (e.g., in a case when the vision data acquired by the smart doorbell 216 is occluded from the camera 136 and/or the cameras 208). The lock 212, the smart doorbell 216, the smart door 220, and/or the home security system 224 are further described in International Patent Publication No. WO2024/006540, filed Jun. 30, 2023, which is incorporated herein by reference in its entirety.

According to an exemplary embodiment, the cameras 208 and/or the smart doorbell 216 are positioned along an exterior of the building 154 in the exterior environment 150 remote from the receptacle 104 to monitor the receptacle 104 and the area surrounding the receptacle 104. By way of example, the cameras 208 and/or the smart doorbell 216 may be positioned to acquire vision data including an area in front of and next to the receptacle 104 to facilitate detecting people and objects in the exterior environment 150. By way of another example, the cameras 208 and/or the smart doorbell 216 may be positioned to acquire vision data including the contents entering or placed in the storage volume 112 and the contents removed or taken out of the storage volume 112.

According to an exemplary embodiment, the water monitoring system 228 is configured to monitor and/or control a water system of the building 154. By way of example, the water monitoring system 228 may include one or more sensors configured to monitor water pressure, a flow of water, among other characteristics of the water system of the building 154. In such an example, based on the data acquired by the one or more sensors, the water monitoring system 228 and/or the server 300 may determine whether water is running in the building 154 (e.g., whether water is flowing out of a faucet, sprinkler, spout, etc.). In some embodiments, the receptacle 104 is inside of the building 154 (e.g., inside of the floor plan 140) and/or one or more of the cameras 208 are inside of the building 154 and are configured to facilitate determining whether the building 154 is occupied by a person (e.g., whether the person is inside of the building 154). In some embodiments, the user device 204 includes one or more sensors (e.g., location sensors, cameras, the camera 258, the sensors 260, etc.) configured to acquire data indicative of the location of the user device 204 and, therefore, the location of the user of the user device 204. Based on the data acquired by the receptacle 104 (e.g., via the sensors 132, the cameras 136, etc.), the cameras 208, and/or the user device 204, the server 300 may determine whether the building 154 is occupied.

In some embodiments, the user device 204 provides the user the ability to configure one or more settings or modes of operation associated with the water monitoring system 228. In such an embodiment, the user may specify one or more characteristic thresholds associated with the water based on whether the user is at home (e.g., inside the building 154) or away from home (e.g., away from the building 154) such that the water monitoring system 228 is controlled in accordance with the specified settings or modes of operation. In response to a determination that (i) the water is running and (ii) the building 154 is not occupied, the water monitoring system 228 and/or the server 300 may determine that the water is unintentionally running (e.g., leaking) and may control the water system of the building 154 to shut off (e.g., to stop the flow of water) and/or notify a user via the user device 204 in accordance with the settings or modes of operation specified by the user. In response to a determination that (i) the water is running and (ii) the building 154 is occupied, the water monitoring system 228 and/or the server 300 may determine that the water is intentionally running (e.g., not leaking) and may permit normal, unrestricted operation of the water system of the building 154 in accordance with the settings or modes of operation specified by the user.

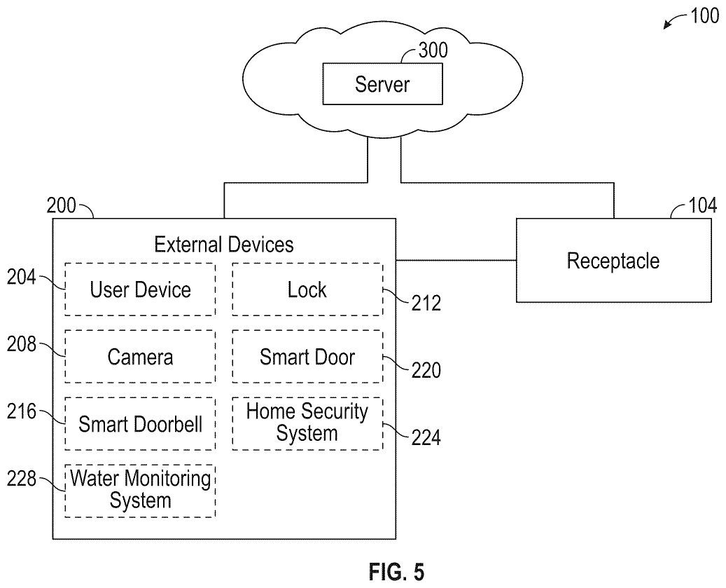

As shown in FIG. 5, the server 300 is configured to communicate with the external devices 200 and the receptacle 104 (e.g., using a first communication protocol, using a long-range communication protocol, cellular, Wi-Fi, radio, etc.) and the external devices 200 (e.g., the user device 204) are configured to communicate with the receptacle 104 (e.g., using a second communication protocol, using a short-range communication protocol, Bluetooth, Bluetooth low energy (“BLE”), near-field communication (“NFC”), radio frequency identification (“RFID”), etc.). In some embodiments, the receptacle 104 is not in communication with the server 300 such that the external devices 200 function as intermediary devices that facilitate data transmissions between the server 300 and the receptacle 104. In some embodiments, the server 300 is or includes a plurality of servers. In some embodiments, the server 300 communicates with a plurality of external devices 200 (e.g., a plurality of user devices 204, a plurality of cameras 208, etc.). In some embodiments, a single external device 200 (e.g., a single user device 204) communicates with a plurality of receptacles 104. In some embodiments, a plurality of external devices 200 (e.g., a plurality of user devices 204, a plurality of cameras 208, etc.) communicate with the receptacle 104.

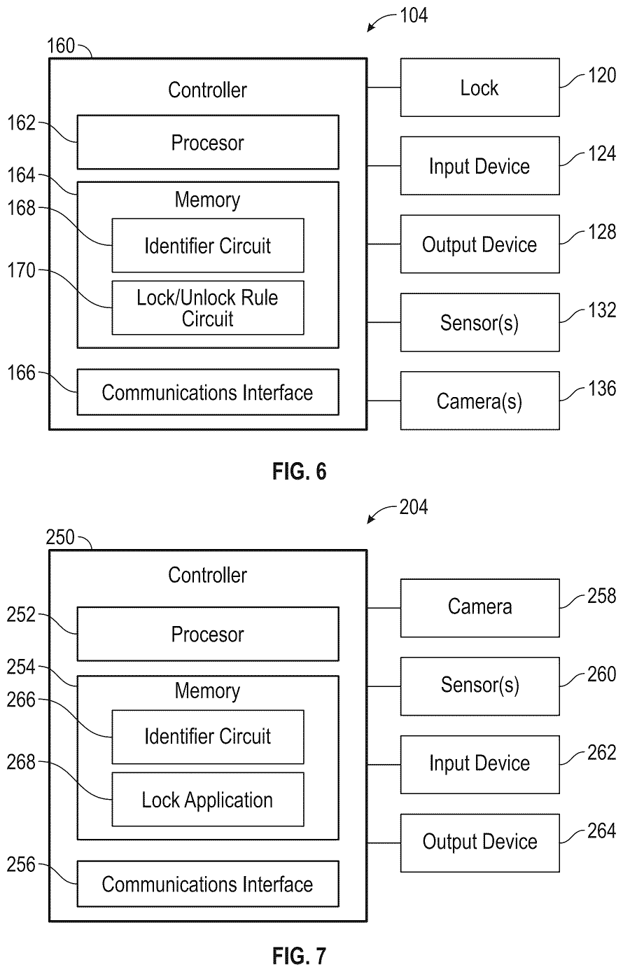

As shown in FIG. 6, the receptacle 104 includes a controller, shown as receptacle controller 160, including a processor 162, a memory 164, and a communications interface 166. The processor 162 may include a general-purpose processor, an ASIC, one or more FPGAs, a DSP, circuits containing one or more processing components, circuitry for supporting a microprocessor, a group of processing components, or other suitable electronic processing components. In some embodiments, the processor 162 is configured to execute computer code stored in the memory 164 to facilitate the activities described herein. The memory 164 may be any volatile or non-volatile computer-readable storage medium capable of storing data or computer code relating to the activities described herein. According to an exemplary embodiment, the memory 164 includes computer code modules (e.g., executable code, object code, source code, script code, machine code, etc.) configured for execution by the processor 162.

In one embodiment, the receptacle controller 160 is configured to selectively engage, selectively disengage, control, or otherwise communicate with components of the receptacle 104 (e.g., via the communications interface 166, a controller area network (“CAN”) bus, etc.). According to an exemplary embodiment, the receptacle controller 160 is coupled to (e.g., communicably coupled to) components of the lock 120 (e.g., an actuator, a motor, an electromagnet, etc.), the input device 124, the output device 128, the sensors 132, and the cameras 136. By way of example, the receptacle controller 160 may send and receive signals (e.g., control signals, etc.) with the components of the lock 120, the input device 124, the output device 128, the sensors 132, the cameras 136, and/or remote systems or devices (via the communications interface 166 as described in greater detail herein).

According to an exemplary embodiment, the communications interface 166 is configured to facilitate (i) long-range communications between the receptacle 104 and the server 300 and (ii) short-range communications between the receptacle 104 and the user device 204. The memory 164 includes an identifier circuit 168 and a lock/unlock rule circuit 170. The identifier circuit 168 is configured to store a lock identifier, a lock key, and/or a manual access code for the receptacle 104. The lock identifier may uniquely identify the receptacle 104 from any other receptacle 104. In some embodiments, the lock identifier is provided to the receptacle 104 at the time of manufacturing. The identifier circuit 168 may be configured to broadcast the lock identifier via the communications interface 166 (e.g., in response to communication with the user device 204, in response to communication with the server 300, in response to a request to access the receptacle 104, etc.) to the user device 204 and/or the server 300. The lock/unlock rule circuit 170 may receive and store locking and unlocking procedure steps and/or other locking and unlocking procedure information. The locking and unlocking procedure information may be received by the receptacle controller 160 from the user device 204 or the server 300 (e.g., in response to a request to access the receptacle 104). In some embodiments, the locking and unlocking procedure information is provided to the lock/unlock rule circuit 170 at the time of manufacturing. In some embodiments, the lock/unlock rule circuit 170 is configured to store information associated with the current state of the receptacle 104, such as a locked state or an unlocked state (e.g., based on sensor data received from one or more sensors 132 of the receptacle 104 configured to acquire position data of the door 116 or the storage compartment 108 indicative of the state of the receptacle 104).

As shown in FIG. 7, the user device 204 includes a controller, shown as user device controller 250, including a processor 252, a memory 254, and a communications interface 256. The processor 252 may include a general-purpose processor, an ASIC, one or more FPGAs, a DSP, circuits containing one or more processing components, circuitry for supporting a microprocessor, a group of processing components, or other suitable electronic processing components. In some embodiments, the processor 252 is configured to execute computer code stored in the memory 254 to facilitate the activities described herein. The memory 254 may be any volatile or non-volatile computer-readable storage medium capable of storing data or computer code relating to the activities described herein. According to an exemplary embodiment, the memory 254 includes computer code modules (e.g., executable code, object code, source code, script code, machine code, etc.) configured for execution by the processor 252.

As shown in FIG. 7, the user device 204 includes a vision sensor, shown as camera 258, one or more sensors (e.g., proximity sensors, motion sensors, position sensors, vision sensors, radar sensors, cameras, force sensors, microphones, biometric sensors, etc.), shown as sensors 260, and one or more operator interfaces, shown as input device 262 and output device 264, coupled to the user device controller 250. According to an exemplary embodiment, the camera 258 functions similar to the cameras 136 and the cameras 208 described above. By way of example, the camera 258 may be configured to acquire vision data of the environment surrounding the user device 204. The sensors 260 may function similarly to the sensors 132 described above. By way of example, the sensors 260 may include a biometric sensor configured to facilitate identifying the user of the user device 204 based on the biometrics (e.g., facial recognition, iris/retinal recognition, fingerprint recognition, gait recognition, etc.) of the user. The input device 262 may include one or more keypads, HMIs including one or more input controls (e.g., touchscreens, buttons, knobs, thumb turns, dials, switches, levers, etc.), or the like. The input device 262 may facilitate user control of the user device 204. The output device 264 may include one or more displays (e.g., LCD displays, LED displays, etc.), lights (e.g., warning lights, LEDs, spotlights, etc.), speakers. The output device 264 may provide information to the user indicative of the operation of the user device 204 and/or the receptacle 104 that the user device 204 is in communication with.

In one embodiment, the user device controller 250 is configured to selectively engage, selectively disengage, control, or otherwise communicate with components of the user device 204 (e.g., via the communications interface 256, a CAN bus, etc.). According to an exemplary embodiment, the user device controller 250 is coupled to (e.g., communicably coupled to) the camera 258, the sensors 260, the input device 262, and the output device 264. By way of example, the user device controller 250 may send and receive signals (e.g., control signals, etc.) with the camera 258, the sensors 260, the input device 262, the output device 264, and/or remote systems or devices (via the communications interface 256 as described in greater detail herein).

According to an exemplary embodiment, the communications interface 256 is configured to facilitate (i) long-range communications between the user device 204 and the server 300 and (ii) short-range communications between the user device 204 and the receptacle 104. The memory 254 includes an identifier circuit 266 and a lock application 268. The identifier circuit 266 is configured to store a user device identifier, a user device key, and/or a unique identifier associated with the user device 204. The user device identifier may uniquely identify the user device 204 from any other user device 204. In some embodiments, the identifier may be a user identifier to uniquely identify a user of the user device 204 (e.g., a user signed into the lock application 268, a user of the user device 204, etc.) from any other user. The identifier circuit 266 may be configured to broadcast the identifier via the communications interface 256 (e.g., in response to communication with the receptacle 104, in response to communication with the server 300, in response to a request to access the receptacle 104, etc.) to the receptacle 104 and/or the server 300.

The lock application 268 may be configured to facilitate user access (via the user device 204) to dashboards including the vision data, permission data, authentication data, information available at the server 300, etc., to provide the user with the ability to manage and operate the lock system 100. By way of example, the lock application 268 may provide the user with the ability to set or change a password associated with the receptacle 104. By way of another example, the lock application 268 may provide the user with the ability to facilitate acquiring vision data via the camera 258 (e.g., capture an image or video, view real-time images or videos, etc.), the cameras 136, and/or the cameras 208 or other sensor data (e.g., biometric data) via the sensors 260 of the user device 204 and/or the sensors 132 of the receptacle 104. In such an example, the user may use the user device 204 to acquire vision data (via the cameras 136, the cameras 208, and/or the camera 258) of the contents being placed into or removed from the receptacle 104 by the user. By way of another example, the lock application 268 may provide the user with the ability to access, view, edit, rename, sort, categorize, delete, replace, or otherwise modify vision data available at the server 300. In such an example, the user may select vision data and the lock application 268 may display the vision data acquired by the cameras 136, the cameras 208, and/or the camera 258. By way of still another example, the lock application 268 may provide the user with the ability to access or view audit data relating to operation of the receptacle 104. In such an example, the audit data may include a timestamp (e.g., time, date, etc.) of when a particular receptacle 104 was locked or unlocked, a location (e.g., based on GPS data collected from the user device 204 or the receptacle 104) of where a particular receptacle 104 was locked or unlocked, who (e.g., which user, which user identifier, etc.) locked or unlocked a particular receptacle 104, a state (e.g., locked state or unlocked state) of a particular receptacle 104 that the user associated with the user device 204 is permitted to access, etc.

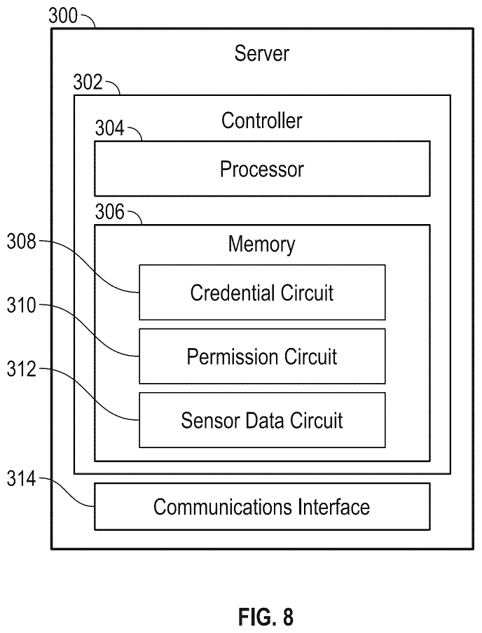

As shown in FIG. 8, the server 300 includes a controller 302 and a communications interface 314. The controller 302 has a processor 304 and a memory 306. The controller 302 may include a general-purpose processor, an ASIC, one or more FPGAs, a DSP, circuits containing one or more processing components, circuitry for supporting a microprocessor, a group of processing components, or other suitable electronic processing components. In some embodiments, the processor 304 is configured to execute computer code stored in the memory 306 to facilitate the activities described herein. The memory 306 may be any volatile or non-volatile computer-readable storage medium capable of storing data or computer code relating to the activities described herein. According to an exemplary embodiment, the memory 306 includes computer code modules (e.g., executable code, object code, source code, script code, machine code, etc.) configured for execution by the processor 304.

According to an exemplary embodiment, the communications interface 314 is configured to facilitate wireless communication from and to the server 300 (i) directly to and from the user device 204 and (ii) directly to and from the receptacle 104 (or indirectly to and from the receptacle 104 through the user device 204). The server 300 may communicate with the user device 204 directly or via an intermediate network (e.g., an internet network, a cellular network, etc.). For example, the communications interface 314 may include physical network components (e.g., a network card, etc.) configured to allow the server 300 to establish a connection to the user device 204. In one embodiment, communications from the communications interface 314 are routed through a cellular interface, allowing the server 300 to communicate with the user device 204 via a cellular network. In one embodiment, the communications interface 314 allows the server 300 to establish an Internet-based connection with the user device 204. The server 300 may be one server (a physical or virtual server) or may include multiple servers.

According to an exemplary embodiment, the server 300 is configured to manage a plurality of access credentials or user profiles for a plurality of users that have access to at least one receptacle 104 of a plurality of receptacles 104 (e.g., group, fleet, etc.). In some embodiments, the memory 306 of the server 300 includes various modules or circuits configured to (i) generate and securely store lock identifiers, user identifiers, and user profiles, (ii) selectively provide control commands (e.g., authorization signals associated with a command to lock the receptacle 104) to the user device 204 and the receptacle 104 based on the permissions of the users (e.g., clearance/authorization level, time schedule, etc.) of the user device 204, (iii) store and process vision data acquired by the cameras 136, the cameras 208, and/or the cameras 258, and/or other possible factors.

As shown in FIG. 8, the memory 306 of the server 300 includes a credential circuit 308, a permission circuit 310, and a sensor data circuit 312. The credential circuit 308 is configured to generate and securely store the lock identifiers (e.g., which may be provided to the receptacle 104 at the time of manufacturing, etc.). As an example, the credential circuit 308 may include a first database of lock identifiers and may include the software configured to store and retrieve such lock identifiers from the first database. The credential circuit 308 may be further configured to facilitate updating, replacing, and/or deleting the lock identifiers (e.g., if a respective lock identifier on a respective receptacle 104 is compromised, etc.).

The credential circuit 308 may be further configured to generate and securely store the user identifiers (e.g., when a user is registered to a respective receptacle 104, etc.). As an example, the credential circuit 308 may include a second database of user identifiers and may include the software configured to store and retrieve such user identifiers from the second database. The credential circuit 308 may be further configured to facilitate updating, replacing, and/or deleting the user identifiers (e.g., if a user's access is revoked, if a user identifier expires, etc.), which may be updated in the associated user profiles as necessary.

The credential circuit 308 may be further configured to generate and securely store the user profiles. As an example, the credential circuit 308 may include a third database of user profiles and may include the software configured to store and retrieve such user profiles from the third database. The credential circuit 308 may be further configured to facilitate updating, replacing, and/or deleting the user profiles (e.g., if a user's access is revoked, if a user identifier is updated, etc.). By way of example, the credential circuit 308 may be configured to generate a user profile for a specific user and/or receptacle 104 when a new user is added to a respective receptacle 104. The user profiles may be associated with a user identifier associated with a specific user who has access to one or more receptacles 104. Each receptacle 104 accessible by the particular user is associated with a particular lock identifier, each of which may be included in the user profile. The user profiles may include audit data relating to operation of the receptacle 104 that the user associated with the user profile is permitted to access (e.g., lock and unlock). By way of example, the audit data may include a timestamp (e.g., time, date, etc.) of when a particular receptacle 104 was locked or unlocked, a location (e.g., based on GPS data collected from the user device 204 or the receptacle 104) of where a particular receptacle 104 was locked or unlocked, who (e.g., which user, which user identifier, etc.) locked or unlocked a particular receptacle 104, a state (e.g., locked state or unlocked state) of a particular receptacle 104 that the user associated with the user profile is permitted to access.

The permission circuit 310 is configured to receive and store access permissions (e.g., access credentials) for users associated with one or more of the receptacles 104. The access permissions may include an authorization or clearance level of the user (e.g., administrator clearance, limited clearance, etc.) that defines which of the receptacles 104 the respective user is able to access and/or limit their access thereto. By way of example, a first user may only unlock or lock a respective receptacle 104 but not change the settings thereof, while a second user may unlock or lock the respective receptacle 104 and change the settings thereof. In some embodiments, a respective receptacle 104 accessible by a first user may be accessible by a second user in response to an authorization granted to the second user by the first user to access the respective receptacle 104. In such embodiments, one-time authorization permissions that allow the second user to unlock the respective receptacle 104 are stored on the permission circuit 310. The access permissions may also include an access schedule that limits the times a user may access a respective receptacle 104. The permission circuit 310 may be configured to facilitate updating the user profiles to include the lock identifiers associated with the respective receptacles 104 that the user (e.g., the user identifier) is authorized to access based on the access permissions stored on the permission circuit 310.

In some embodiments, an authorized user (e.g., a manager, a supervisor, etc.) may have access to the access permissions stored on the permission circuit 310. In such embodiments, the authorized user can view, update, delete, or otherwise modify the access permissions data of each user profile and the audit data of each user profile (e.g., the location of where a receptacle 104 was accessed (or an attempt to access) and by whom, and the time/date of when a receptacle 104 was accessed (or an attempt to access) and by whom).

When attempting to access a receptacle 104 (e.g., transition the receptacle 104 between the locked state and the unlocked state), access may be granted or denied based on at least one of (i) an input to the input device 124 of the receptacle 104, (ii) an input to the input device 262 of the user device 204, (iii) vision data acquired by the sensors 132, the cameras 136, the cameras 208, the camera 258, and/or the sensors 260, and/or (iv) biometric data acquired by the sensors 132 and/or the sensors 260. The input to the input device 124 of the receptacle 104 may include a password as discussed in greater detail above. In response to receiving a user input to the input device 124, the server 300 may compare the user input to an authenticator key stored on the permission circuit 310. The access permissions of the permission circuit 310 may be queried through to determine whether the user input matches the authenticator key. If a match is found, a determination is made that the user input is valid and that the user is authorized to access (e.g., lock/unlock) the receptacle 104. If no match is found, a determination is made that the user input is not valid and that the user is unauthorized to access the receptacle 104. Additionally or alternatively, the receptacle controller 160 may compare the user input to an access key stored thereon and make an access decision locally.

The input to the input device 262 of user device 204 may include a password as discussed in greater detail above. In response to receiving a user input to the input device 262, the server 300 may compare the user input to an authenticator key stored on the permission circuit 310. The access permissions of the permission circuit 310 may be queried through to determine whether the user input matches the authenticator key. If a match is found, a determination is made that the user input is valid and that the user is authorized to access (e.g., lock/unlock) the receptacle 104. If no match is found, a determination is made that the user input is not valid and that the user is unauthorized to access the receptacle 104. Additionally or alternatively, in response to an attempt to access the receptacle 104 via the user device 204, the communication protocol may be initiated between the receptacle 104 and the user device 204 to transmit data therebetween (e.g., exchange lock identifiers, user device identifiers, user profile identifiers, etc.). By way of example, in response to establishing communication with the receptacle 104, the user device 204 may receive the lock identifier from the receptacle 104 (e.g., the lock identifier stored in the identifier circuit 168 of the memory 164 and uniquely associated with the particular receptacle 104 in communication with the user device 204). In some embodiments, the receptacle 104 transmits a signal associated with the state of the receptacle 104 (e.g., locked state or unlocked state) based on sensor data received from the sensors 132. The user device 204 may transmit a signal associated with the lock identifier and the state of the receptacle 104 to the server 300, and/or the receptacle 104 may transmit a signal associated with the lock identifier and the state of the receptacle 104 to the server 300. Additionally, the user device 204 and/or the receptacle 104 may transmit a signal associated with (i) the user identifier uniquely associated with the particular user (e.g., a particular user profile, a particular user device 204, etc.), (ii) a location (e.g., based on GPS data acquired from a location sensor of the user device 204 or the receptacle 104) of the attempt to access the receptacle 104, and (iii) a time/date of the attempt to access the receptacle 104 to the server 300.

In response to receiving the signal from the user device 204 and/or the receptacle 104, the database of user profiles stored on the credential circuit 308 may be queried through to match a user identifier of one of the user profiles with the user identifier received from the user device 204. If a match is found, the credential circuit 308 may update the matched user profile with the audit data received from the user device 204 and/or the receptacle 104 (e.g., update the user profile with the location and time/date of the attempt, update the user profile with the state of the receptacle 104, etc.). In response to receiving the signal from the user device 204 and/or the receptacle 104, the access permissions of the permission circuit 310 may be queried through to determine whether the user has the authorization to access the receptacle 104. By way of example, the access permissions may be queried through to match the received lock identifier with a list of lock identifiers associated with receptacles 104 that the received user identifier is authorized to access. If a match is found, a determination is made that the user device 204 is authorized to access (e.g., lock/unlock) the receptacle 104. If no match is found, a determination is made that the user device 204 is unauthorized to access the receptacle 104. Additionally or alternatively, the receptacle controller 160 may compare a user input transmitted thereto by the user device 204 to an access key stored thereon and make an access decision locally

According to an exemplary embodiment, the sensor data circuit 312 is configured to receive and process the vision data acquired by the cameras 136, the cameras 208, and the camera 258 (as discussed in greater detail below). The vision data may include a user attempting to access the receptacle 104. In response to receiving the vision data, the server 300 may compare the vision data to a database of stored vision data (e.g., stored on the sensor data circuit 312) including users that are authorized to access the receptacle 104. The database of stored vision data of the sensor data circuit 312 may be queried through to determine whether the received vision data matches the stored vision data (e.g., whether a facial recognition match is found). If a match is found (e.g., based on facial recognition), a determination is made that the user included in the received vision data is authorized to access (e.g., lock/unlock) the receptacle 104. If no match is found, a determination is made that the user included in the received vision data is unauthorized to access the receptacle 104.

According to an exemplary embodiment, the sensor data circuit 312 is configured to receive and process the sensor data acquired by the sensors 132 and the sensors 260 (as discussed in greater detail below). The sensor data may include a biometric data of a user attempting to access the receptacle 104. In response to receiving the biometric data, the server 300 may compare the biometric data to a database of stored biometric data (e.g., stored on the sensor data circuit 312) including biometric data of users that are authorized to access the receptacle 104. The database of stored biometric data of the sensor data circuit 312 may be queried through to determine whether the received biometric data matches the stored biometric data (e.g., whether an iris/retinal, voice, gait, etc. match is found). If a match is found, a determination is made that the user associated with the received biometric data is authorized to access (e.g., lock/unlock) the receptacle 104. If no match is found, a determination is made that the user associated with the received biometric data is unauthorized to access the receptacle 104. Additionally or alternatively, the receptacle controller 160 may compare the biometric input to a biometric template stored thereon and make an access decision locally.

In response to a determination that the user is authorized or unauthorized to access the receptacle 104, the server 300 may generate a command signal and transmit the command signal to the receptacle 104 and/or the user device 204. By way of example, in response to a determination based on at least one, two, three, or four of (i) an input to the input device 124 of the receptacle 104, (ii) an input to the input device 262 of the user device 204, (iii) vision data acquired by the sensors 132, the cameras 136, the cameras 208, the camera 258, and/or the sensors 260, or (iv) biometric data acquired by the sensors 132 and/or the sensors 260, that the user is authorized or unauthorized to access the receptacle 104, the server 300 may generate a command signal and transmit the command signal to the receptacle 104 and/or the user device 204. If the command signal is associated with a determination that the user is authorized to access the receptacle 104, the processor 162 of the receptacle 104 may execute the lock and unlock procedure steps stored on the lock/unlock rule circuit 170. The lock and unlock procedure steps may include transmitting a signal to the lock 120, thereby transitioning the receptacle 104 from the locked state to the unlocked state (e.g., or from the unlocked state to the locked state). If the command signal is associated with a determination that the user is unauthorized to access the receptacle 104, the lock and unlock procedure steps are not executed and the receptacle 104 does not transition between the locked and unlocked states.

It should be understood that the authentication scheme described herein is not meant to be limiting, but is provided as an example of one possible way to provide secure communication between the receptacle 104, the user device 204, and the server 300. In other embodiments, secure communication is otherwise established using a different authentication scheme such as an authentication scheme that employs digital signatures, challenge-response procedures, multi-factor authentication (e.g., two-factor authentication, user profile plus a biometric, a user profile plus a PIN, etc.), and/or still other suitable authentication schemes.

According to an exemplary embodiment, the sensor data circuit 312 is configured to receive and process the vision data and the sensor data acquired by the sensors 132, the cameras 136, the cameras 208, the camera 258, and the sensors 260. The sensor data circuit 312 may include an object detector (e.g., object detection circuit) including a neural network or other similar model for processing received data (e.g., from the sensors 132, the cameras 136, the cameras 208, the camera 258, the sensors 260, etc.) to detect the contents placed in or removed from the receptacle 104. By way of example, the sensor data circuit 312 may include or may be configured to utilize a machine learning (e.g., deep learning) algorithm to identify the contents placed in or removed from the receptacle 104. Identifying the contents may include identifying the type (e.g., personal belongings such as jewelry, electronics, money, documents such as tax documents, certificates, titles, etc.) of object placed in or removed from the receptacle 104, or the text (e.g., wording, lettering, numbers, symbols, etc.) on the contents placed in or removed from the receptacle 104, among other characteristics associated with the contents. In some embodiments, the machine learning algorithm is provided inputs in the form of images, sequences of images, videos, among other vision data to identify the contents placed in or removed from the receptacle 104 and the user placing the content in or removing the content from the receptacle 104.

According to an exemplary embodiment, the vision-based detection and identification of the contents is supplemented using data acquired from one or more of the sensors 132 and/or the sensors 260. In some embodiments, the sensors 132 include one or more weight sensors (e.g., load sensors) positioned within the storage compartment 108 along or beneath a floor, shelf, platform, etc., of the storage volume 112 and configured to measure a weight of the contents before and after each access event. In such an embodiment, the controller 302 may correlate changes in weight with the contents detected by the cameras 136 and/or the cameras 208 to confirm the presence, count, and/or identification of the contents placed in or removed from the receptacle 104. By way of example, the controller 302 may use the weight data to distinguish between similarly appearing content (e.g., a first item appears visually similar to a second item, but the weight of the first item is different than the weight of the second item). By way of another example, the controller 302 may use the weight data to detect removal of an item that is occluded from the cameras 136 and/or the cameras 208 (e.g., the removed item is not in the field of view of the cameras 136 and/or the cameras 208, but the reduced weight detected by the weight sensors indicates removal of the item). By way of still another example, the controller 302 may use the weight data to confirm that a visually detected item was actually placed into or removed from the receptacle 104 (e.g., in response to the weight sensors detecting an increase in weight or a decrease in weight in the receptacle 104, respectively). In other embodiments, the sensors 132 include one or more color sensors positioned within the storage compartment 108 and configured to acquire data indicative of a color of the contents placed into or removed from the receptacle 104. By way of example, the controller 302 may use color data to distinguish between similarly shaped, sized, weighted content (e.g., a first item appears visually similar or weighs similarly to a second item, but the color of the first item is different than the color of the second item). In still other embodiments, the sensors 132 include one or more other sensors, such as proximity sensors, infrared sensors, RFID, NFC, and/or BLE readers, etc., configured to monitor the contents for one or more other characteristics to provide supplementary data (e.g., in addition or as an alternative to vision data) to facilitate detecting and identifying the contents placed into or removed from the receptacle 104.

In response to an access event (e.g., when access to the receptacle 104 is granted, denied, attempted, etc.), the sensors 132, the cameras 136, the cameras 208, the camera 258, and/or the sensors 260 are configured to acquire data including the contents being placed in or removed from the receptacle 104. In some embodiments, one or more of the cameras 136 are positioned within the storage volume 112 and have a field of view including an opening of the receptacle 104 and the storage volume 112. In such embodiments, when the door 116 is in the closed position, the cameras 136 may acquire data including the contents within the receptacle 104. Further, in such embodiments, when the door 116 is moved from the closed position to the open position or when the storage compartment 108 is transitioned from the stowed position to the extended position, the cameras 136 may acquire data including the contents being placed in or removed from the receptacle 104 (e.g., thereby enabling the lock system 100 to detect and log the contents associated with each access event).

According to an exemplary embodiment, the sensor data circuit 312 is configured to identify the user associated with the access event, identify the contents, and catalog (e.g., save) digital copies (e.g., scans, digital twins, etc.) of the contents based on the data acquired by the sensors 132, the cameras 136, the cameras 208, the camera 258, and/or the sensors 260. In some embodiments, the copies of the contents are cataloged (e.g., in a digital inventory as described in greater detail below) based on the type of the contents, the information on the contents, the person who deposited the contents, etc. In some embodiments, the sensor data circuit 312 is configured to detect anomalies and anomaly conditions associated with the adding or removal of the contents to or from the receptacle 104. By way of example, the sensor data circuit 312 may compare the number of items placed in and removed from the receptacle 104 to identify discrepancies and provide an alert (e.g., via the output device 128, the user device 204, etc.) to users indicative of the discrepancies. By way of another example, if a user typically (e.g., historically) adds an item to the receptacle 104 without removing an item from the receptacle 104, and the sensor data circuit 312 determines that the user removed an item, the sensor data circuit 312 may identify a discrepancy and provide an alert indicative of the discrepancy. By way of still another example, if a determination is made that a first item is removed from the receptacle 104 during a first access event, but a second item different than the first item is returned to the receptacle 104 during a second, subsequent event, the sensor data circuit 312 may identify a discrepancy and provide an alert indicative of the discrepancy. By way of still another example, a user may identify (via the lock application 268 of the user device 204) a first item that is to be added or removed from the receptacle 104. In such an example, if a second item is added or removed that is different than the identified, first item, the sensor data circuit 312 may identify a discrepancy and provide an alert indicative of the discrepancy.

In some embodiments, the sensor data circuit 312 is configured to detect anomalies and anomaly conditions where an event is expected to occur but does not occur. By way of example, the sensor data circuit 312 may determine, based on the data acquired by the sensors 132, the cameras 136, the cameras 208, the camera 258, and/or the sensors 260, that the user removes a pair of items (e.g., two passports) during a first access event and returns only one of the two items during a subsequent, second access event. In such an example, the sensor data circuit 312 may detect the anomaly condition (e.g., an expected return event for the second item did not occur, a discrepancy, etc.) and provide an alert indicative of the anomaly condition. In such an example, the quantity of items expected to be returned to the receptacle 104 may be based on a work order, reservation, user input, user credentials, user identification, etc. received via the lock application 268, a prior state of the digital inventory (e.g., the prior state of the digital inventory including the two passports), etc. By way of another example, based on historical access data, the sensor data circuit 312 may determine that the user typically places an item into the receptacle 104 at a recurring time (e.g., a timeframe, every weekday at 5:00 PM) without removing any item(s). In such an example, in response to a determination that no item was placed into the receptacle 104 at the recurring time (or in response to a determination that an item was removed from instead of or in addition to being added to the receptacle 104), the sensor data circuit 312 may determine that an expected event did not occur when it should have occurred and provide an alert indicative of the anomaly condition. By way of still another example, based on historical data, the sensor data circuit 312 may determine that items of a respective type or category (e.g., equipment, personal belongings, electronics, money, documents, etc.) removed from the receptacle 104 are typically returned to the receptacle 104 within a predetermined or learned time period (e.g., allowed checkout timeframe, checkout window, within one hour, eight hours, one day, etc.). In such an example, in response to a determination that the removed items have not been returned to the receptacle 104 after the time period (e.g., an expected return event for the removed item did not occur within the time period after removing the items), the sensor data circuit 312 may provide an alert indicative of the anomaly condition.

In some embodiments, the sensor data circuit 312 is configured to detect anomalies and anomaly conditions where an event is determined to have occurred when it should not have occurred. By way of example, the permission circuit 310 may include schedule data indicating that a particular receptacle 104 is not to be accessed during a predetermined timeframe (e.g., between 12:00 AM and 5:00 AM). In such an example, in response to a determination, based on the data acquired by the sensors 132, the cameras 136, the cameras 208, the camera 258, and/or the sensors 260, that the door 116 was moved from the closed position to the open position or the storage compartment 108 was transitioned from the stowed position to the extended position, or that contents were removed from the receptacle 104 during the predetermined timeframe, the sensor data circuit 312 may determine that an unexpected event occurred when it should not have occurred and provide an alert indicative of the anomaly condition. By way of another example, the sensor data circuit 312 may detect that a quantity of items removed from the receptacle 104 (e.g., three items, five items, etc.) exceeds a quantity expected or authorized, and may identify such excess removal as an anomaly (e.g., determine that the access event is associated with an anomaly condition). In such an example, the quantity of items expected or authorized for removal from the receptacle 104 may be based on a work order, reservation, user input, user credentials, user identification, etc. received via the lock application 268 (e.g., one item), a prior state of the digital inventory, etc. By way of still another example, the sensor data circuit 312 may determine, based on the user identifier provided by the user device 204 and/or biometric or vision data, that a respective user is not authorized to access specific categories or types of contents (e.g., restricted content) stored within the storage volume 112. In such an example, in response to a determination, based on the data acquired by the sensors 132, the cameras 136, the cameras 208, the camera 258, and/or the sensors 260, that the respective user has removed or attempted to remove an item (e.g., the restricted content) belonging to a restricted type or category, the sensor data circuit 312 may determine that an unexpected event occurred when it should not have occurred and provide an alert indicative of the anomaly condition. While the above cataloging and anomaly detection process is described as being performed by the server 300, it should be understood that such process may be performed locally at the receptacle 104, locally at the user device 204, or a combination of the server 300, the receptacle 104, and/or the user device 204.

According to an exemplary embodiment, in response to detecting an anomaly or anomaly condition, the lock system 100 is configured to perform one or more actions (e.g., preventative actions, alert actions, etc.). In some embodiments, the controller 302 generates an alert signal that is transmitted to the receptacle 104 and/or the user device 204. In such an embodiment, the receptacle 104 may provide an alert via the output device 128 (e.g., illuminate a light, display a message, emit an audible tone or spoken message, etc.) to indicate that the anomaly was detected. Further, in such an embodiment, the user device 204 may provide an alert via the output device 264 (e.g., illuminate a light, display a message, emit an audible tone or spoken message, send an email, provide a push notification, etc.) to indicate that the anomaly was detected.

In some embodiments, the controller 302 is configured to associate the detected anomaly with corresponding vision data and/or sensor data. By way of example, in response to detecting the anomaly, the controller 302 may identify a timeframe within which the anomaly occurred (e.g., several seconds or minutes before and after the anomaly) and store the relevant vision data acquired by the cameras 136, the cameras 208, and/or the camera 258, and the relevant sensor data from the sensors 132 and the sensors 260 acquired within the timeframe. The lock application 268 may provide the user with an interface to view the anomaly and the associated vision data (e.g., a video clip showing the user removing an item that was not subsequently returned, an access event at an unexpected time, etc.), thereby enabling the user to review the context of the anomaly and determine an appropriate response.

In some embodiments, in response to detecting the anomaly or anomaly condition, the receptacle controller 160 may control the receptacle 104 to enter a restricted operation mode. By way of example, in response to an anomaly indicative of a missing item, the receptacle controller 160 may control the lock 120 to transition to and remain in the locked state until the anomaly is acknowledged and/or resolved by an authorized user. In other embodiments, the receptacle controller 160 may prevent the receptacle 104 from transitioning from the unlocked state to the locked state until the anomaly has been addressed (e.g., to force a physical inspection of the contents). In some embodiments, the credential circuit 308 and/or the permission circuit 310 may be updated to temporarily restrict access to the receptacle 104 to a smaller set of users (e.g., administrators only, owners only, etc.) until the anomaly has been resolved. In some embodiments, the lock application 268 enables an authorized user to annotate a respective anomaly (e.g., “user had verbal authorization,” etc.) and/or mark the anomaly as resolved. In such an embodiment, the server 300 may store such annotations and resolutions as part of the audit data associated with the user profiles and the receptacle 104. In other embodiments, repeated or unresolved anomalies may trigger escalated actions, such as generating higher-priority alerts, notifying additional users or security personnel, etc.

According to an exemplary embodiment, the sensor data circuit 312 stores (e.g., maintains) a digital inventory of the contents in the receptacle 104. The digital inventory may be accessible via the lock application 268 of the user device 204. As discussed above, the lock application 268 provides the user with the ability to view images (e.g., digital copies) of the contents, add/edit/delete descriptions (e.g., names, categories, etc.) to the contents, and/or manage the digital inventory (e.g., sort the contents, move the contents into digital folders, etc.), among other capabilities. The data (e.g., vision data, sensor data, etc.) received by the sensor data circuit 312 may be used to generate digital copies of documents, such as PDFs, by capturing high-fidelity images that are processed to match the quality of traditional scans. In some embodiments, the sensors 132, the cameras 136, and the cameras 208 automatically capture data including the contents being added or removed from the receptacle 104 (or the contents stored in the storage volume 112 with the cameras 136 positioned within the storage volume 112) without any input from the user (e.g., without requiring the user to hold a document in front of the sensors 132, the cameras 136, or the cameras 208 before adding or removing the document). In other embodiments, the camera 258 and/or the sensors 260 of the user device 204 capture data of the contents being added or removed from the receptacle 104 (e.g., the user manually provides an input to take a picture, scan, etc. a document before adding or removing the document). Capturing data including the contents enables the sensor data circuit 312 to create the digital inventory to back up important documents to the server 300 without the need for a separate scanning device.

According to an exemplary embodiment, in response to an access event (e.g., when contents are added to or removed from the storage volume 112), the controller 302 is configured to update the digital inventory based on the contents being added to or removed from the storage volume 112. As described in greater detail above, the controller 302 may identify the contents added to or removed from the storage volume 112 using the data acquired by the sensors 132, the cameras 136, the cameras 208, the camera 258, and/or the sensors 260. Based on the identification of the contents, the controller 302 may generate, modify, or remove entries in the digital inventory to reflect the state of the contents stored in the storage volume 112.

In some embodiments, in response to detecting that an item has been added to the storage volume 112 during an access event, the controller 302 updates the digital inventory to create a new inventory entry corresponding to the added item. The new inventory entry may include (i) one or more images (e.g., digital copies, scans, digital twins, etc.) of the item, (ii) an item name (e.g., “passport,” “house key,” “tax return 2024,” etc.), (iii) an item category (e.g., documents, keys, valuables, electronics, confidential, etc.), (iv) a timestamp of when the item was added, (v) an identifier of the user who added the item (e.g., based on the user identifier, biometric data, vision data, etc.), and/or (vi) any additional information (e.g., weight, dimensions, color, etc.) based on the sensor data and/or a user input.

In some embodiments, in response to detecting that an item has been removed from the storage volume 112 during an access event, the controller 302 updates the digital inventory (e.g., updates the inventory entry corresponding to the removed item) to indicate that the item is no longer present in the receptacle 104. In such embodiments, the inventory entry may be removed from an active inventory list (e.g., a list of items actively in the storage volume 112) and moved to a removed items list. In other embodiments, the inventory entry remains in the active inventory list but is visually modified (e.g., annotated) to indicate that the item has been checked out or is currently removed from the receptacle 104. By way of example, the lock application 268 may display the inventory entry of the removed item as grayed-out, hatched, marked with a checked out icon, or otherwise visually distinguished from items actively in the storage volume 112.

In some embodiments, the controller 302 maintains, for each inventory entry, a status indicative of whether the corresponding item is in the receptacle 104, checked out, permanently removed, pending return, or in another status. In such embodiments, in response to detecting an item being removed from the receptacle 104, the status for the corresponding inventory entry may be updated from being in the receptacle 104 to being checked out, permanently removed, or pending return. Similarly, in response to detecting that an item previously removed has been returned to the receptacle 104, the controller 302 may update the status from checked out or pending return back to being in the receptacle 104.

In some embodiments, the controller 302 is configured to associate information relating to a checkout (e.g., removal from the receptacle 104) for each item that is removed from the receptacle 104 with the corresponding inventory entry in the digital inventory. By way of example, in response to an item being removed, the controller 302 may (i) identify the user associated with the removal (e.g., based on the user identifier, biometric data, vision data, etc.), (ii) record a timestamp (e.g., date and time of removal), and/or (iii) determine and store an expected return time or return window (e.g., based on rules defined for the item, typical usage patterns, work orders, reservations, etc.). In such embodiments, the lock application 268 may display the identity of the user who checked the item out, when the item was checked out, and how long the item has been checked out for (e.g., elapsed time since removal), and may indicate whether the item is overdue based on the expected return time or return window.

According to an exemplary embodiment, the lock application 268 provides the user with the ability to view, organize, and manage the digital inventory. By way of example, the user may (i) sort and filter entries (e.g., show only items currently checked out, only documents, overdue items, items associated with a respective user, etc.), (ii) search for entries, and/or (iii) organize entries into folders (e.g., by client, project, time period, item type, etc.). In some embodiments, the lock application 268 provides the user with the ability to view the digital copies associated with the inventory entries. The user may also generate and export copies of the digital inventory or selected entries thereof, including printing one or more documents or items (e.g., via a printer) and/or exporting the digital inventory or selected entries thereof as digital files (e.g., PDFs, image files, etc.). In some embodiments, the lock application 268 provides the user with the ability to annotate inventory entries (e.g., update the file name, etc.).

In some embodiments, the permission circuit 310 and/or the sensor data circuit 312 are configured to store and apply one or more rules associated with the digital inventory. By way of example, an authorized user may, via the lock application 268, define rules specifying expected quantities, storage durations, among other rules for the contents in the receptacle 104. In such an example, the rules may be specific to a particular type or category associated with a respective item (e.g., documents must be returned within one business day, only authorized users may remove items in a “confidential” category, etc.). The controller 302 may compare the detected inventory changes (i.e., the adding and removal of items from the receptacle 104) with the rules, and, in response to detecting a violation of a rule, determine that an anomaly has occurred (as described in greater detail above). In some embodiments, the controller 302 is configured to learn “normal” patterns of behavior over time for individual users, groups of users, and/or specific receptacles 104, thereby enabling dynamic thresholds (e.g., typical times of access, typical numbers of items removed, typical return intervals, etc.) used to detect anomalies.

As used herein, an “anomaly condition” may refer to any condition or state detected by the lock system 100 that is indicative of a discrepancy between expected behavior or expected contents and observed behavior or observed contents. The anomaly condition may include, for example, discrepancies between (i) an expected number, type, category, and/or identity of items to be added to or removed from the receptacle 104 and an actual number, type, category, and/or identity of items detected as being added to or removed from the receptacle 104, (ii) an expected time or timeframe of an access event and an actual time or timeframe of the access event, (iii) an expected user or user authorization level associated with an access event and an actual user or user authorization level identified for the access event, (iv) an expected duration for which an item is to remain outside or inside the receptacle 104 and an actual duration for which the item remains outside or inside the receptacle 104, and/or (v) one or more rules, policies, and/or learned usage patterns and the inventory changes or access events detected by the lock system 100. An anomaly condition may be detected based on vision data, sensor data, permission data, rule-based data, and/or learned data, and includes the various anomalies or discrepancies described herein.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the lock system 100 and the systems and components thereof (e.g., the receptacle 104, the external devices 200, the server 300, etc.) as shown in the various exemplary embodiments is illustrative only. Additionally, any element disclosed in one embodiment may be incorporated or utilized with any other embodiment disclosed herein.

1. A lock system comprising:
a receptacle including:
a storage compartment defining a storage volume; and
a lock transitionable between a locked configuration and an unlocked configuration, wherein, in the locked configuration, access to the storage volume is inhibited, and, in the unlocked configuration, access to the storage volume is permitted;
a sensor configured to acquire sensor data regarding contents added to or removed from the storage volume by a user; and
one or more processing circuits configured to:
acquire the sensor data from an access event associated with the receptacle;
identify, based on the sensor data, at least one item of the contents added to or removed from the storage volume during the access event;
determine, based on the sensor data and the at least one item, whether the access event is associated with an anomaly condition; and
generate an alert signal in response to determining that the access event is associated with the anomaly condition.

2. The lock system of claim 1, wherein the one or more processing circuits are configured to determine that the access event is associated with the anomaly condition in response to a first number of items identified as added to or removed from the storage volume during the access event being different from an expected number of items to be added to or removed from the storage volume.

3. The lock system of claim 2, wherein the first number of items identified as added to the storage volume during the access event is different from the expected number of items to be added to the storage volume.

4. The lock system of claim 3, wherein the expected number of items is a second number of items identified as removed from the storage volume during a previous access event.

5. The lock system of claim 2, wherein the first number of items identified as removed from the storage volume during the access event is different from the expected number of items to be removed from the storage volume.

6. The lock system of claim 5, wherein the expected number of items is a second number of items identified based on at least one of credentials or an identity of the user, a time of day, based on a user input to an external device, or as added to the storage volume during a previous access event.

7. The lock system of claim 1, wherein the one or more processing circuits are configured to:
determine a recurring timeframe at which the access event typically occurs; and
determine that the anomaly condition is present in response to the access event not occurring within the recurring timeframe.

8. The lock system of claim 1, wherein the one or more processing circuits are configured to:
determine a predetermined time period associated with the at least one item; and
determine that the access event is associated with the anomaly condition in response to the at least one item not being added to the storage volume within the predetermined time period after the at least one item was removed from the storage volume.

9. The lock system of claim 1, wherein the one or more processing circuits are configured to:
identify a respective time at which the access event occurred;
determine that the respective time is outside of an allowed access timeframe; and
determine that the access event is associated with the anomaly condition in response to determining that the respective time is outside of the allowed access timeframe.

10. The lock system of claim 1, wherein the one or more processing circuits are configured to:
access permission data associated with a user identifier for the user, the permission data defining one or more restricted categories of contents stored in the storage volume;
determine, based on the permission data, that the user is not authorized to remove items belonging to at least one of the restricted categories of contents;
determine, based on the sensor data, that the at least one item removed by the user belongs to the at least one restricted category of contents; and
determine that the access event is associated with the anomaly condition in response to determining that the item removed by the user belongs to the at least one restricted category of contents.

11. The lock system of claim 1, wherein the sensor includes one or more cameras at least one of positioned within the storage volume, positioned along an exterior of the receptacle, or separate from the receptacle.

12. The lock system of claim 1, wherein the sensor includes a weight sensor positioned within the storage compartment and configured to measure a weight of the contents in the storage volume before and after the access event, and wherein the one or more processing circuits are configured to identify the at least one item based at least in part on a change in the weight.

13. The lock system of claim 1, wherein the sensor is configured to acquire data indicative of a color of the contents, and wherein the one or more processing circuits are configured to use the color to distinguish between items having similar shapes, sizes, or weights.

14. The lock system of claim 1, wherein the one or more processing circuits are configured to:
maintain a digital inventory of the contents stored in the storage volume; and
update the digital inventory based on the at least one item added to or removed from the storage volume during the access event.

15. The lock system of claim 14, wherein updating, by the one or more processing circuits, the digital inventory includes at least one of:
creating a new inventory entry for the at least one item in response to detecting that the at least one item has been added to the storage volume; or
modifying an existing inventory entry corresponding to the at least one item to indicate that the at least one item has been removed from the storage volume.

16. The lock system of claim 14, wherein the one or more processing circuits are configured to generate, using the sensor data, a digital copy of the at least one item in the digital inventory.

17. The lock system of claim 1, wherein the one or more processing circuits are configured to transmit the alert signal to cause an output device of at least one of the receptacle or a user device to provide an alert indicative of the anomaly condition.

18. The lock system of claim 1, wherein the one or more processing circuits include at least one of (i) a first processing circuit located on the receptacle or (ii) a second processing circuit located remote from the receptacle.

19. A lock system comprising:
one or more processing circuits configured to:
acquire sensor data from an access event associated with a receptacle, the receptacle including a storage compartment defining a storage volume configured to store contents and a lock configured to permit selective access to the storage volume;
identify, based on the sensor data, at least one item of the contents added to or removed from the storage volume during the access event;
determine, based on the sensor data and the at least one item, whether the access event is associated with an anomaly condition; and
generate an alert signal in response to determining that the access event is associated with the anomaly condition;
wherein the one or more processing circuits are configured to determine that the access event is associated with the anomaly condition in response to a first number of items identified as added to or removed from the storage volume during the access event being different from an expected number of items to be added to or removed from the storage volume.

20. A lock system comprising:
a receptacle including:
a storage compartment defining a storage volume; and
a lock transitionable between a locked configuration and an unlocked configuration, wherein, in the locked configuration, access to the storage volume is inhibited, and, in the unlocked configuration, access to the storage volume is permitted;
a sensor configured to acquire sensor data regarding contents stored in, added to, or removed from the storage volume by a user; and
one or more processing circuits configured to:
acquire the sensor data;
identify, based on the sensor data, one or more items of the contents stored in the storage volume;
maintain a digital inventory representing the contents stored in the storage volume, the digital inventory including a digital copy of the one or more items of the contents; and
update the digital inventory based on a respective item of the contents being added to or removed from the storage volume.
